(19) United States
(12) Patent Application Publication
(10) Pub. No.: US 2018/0115764 A1
(43) Pub. Date: Apr. 26, 2018

(54) METHOD AND APPARATUS OF MOTION AND DISPARITY VECTOR PREDICTION AND COMPENSATION FOR 3D VIDEO CODING

(71) Applicant: HFI INNOVATION INC., Zhubei City (TW)

(72) Inventors: Jian-Liang LIN, Yilan County (TW); Yi-Wen CHEN, Taichung (TW); Yu-Pao TSAI, Kaohsiung (TW); Yu-Wen HUANG, Taipei (TW); Shaw-Min LEI, Hsinchu County (TW)

(73) Assignee: HFI INNOVATION INC., Zhubei City (TW)

(21) Appl. No.: 15/849,207

(22) Filed: Dec. 20, 2017

Related U.S. Application Data
(63) Continuation of application No. 14/115,076, filed on Oct. 31, 2013.
(60) Provisional application No. 61/497,438, filed on Jun. 15, 2011.

(51) Int. Cl. H04N 13/00; H04N 19/593; H04N 19/513; H04N 19/70; H04N 19/597; H04N 19/58; H04N 19/52

(52) U.S. Cl. CPC H04N 13/0048; H04N 19/593; H04N 19/513; H04N 19/70; H04N 19/52; H04N 19/58; H04N 19/597

(57) ABSTRACT

A method and apparatus for deriving MV/MVP (motion vector or motion vector predictor) or DV/DVP (disparity vector or disparity vector predictor) associated Skip mode, Merge mode or Inter mode for a block of a current picture in three-dimensional (3D) video coding are disclosed. The 3D video coding may use temporal prediction and inter-view prediction to exploit temporal and inter-view correlation. MV/DV prediction is applied to reduce bitrate associated with MV/DV coding. The MV/MVP or DV/DVP for a block is derived from spatial candidates, temporal candidates and inter-view candidates. For the inter-view candidate, the position of the inter-view co-located block can be located using a global disparity vector (GDV) or warping the current block onto the co-located picture according to the depth information. The candidate can also be derived as the vector corresponding to warping the current block onto the co-located picture according to the depth information.

### CROSS REFERENCE TO RELATED APPLICATIONS

This application is a continuation application of U.S. application Ser. No. 14/115,076, filed Oct. 31, 2013, which is the U.S. National Stage application of PCT International Application No. PCT/CN2012/076643 filed Jun. 8, 2012, which claims priority to U.S. Provisional Patent Application Ser. No. 61/497,438, filed Jun. 15, 2011, entitled “Method for motion vector prediction and disparity vector prediction in 3D video coding”. The present invention is also related to U.S. Non-Provisional patent application Ser. No. 13/236,422, filed Sep. 19, 2011, entitled “Method and Apparatus for Deriving Temporal Motion Vector Prediction”. The U.S. Provisional Patent Application and U.S. Non-Provisional Patent Applications are hereby incorporated by reference in their entireties.

### BACKGROUND OF THE INVENTION

### Field of the Invention

The present invention relates to video coding. In particular, the present invention relates to motion/disparity vector prediction and information sharing of motion/disparity compensation in 3D video coding.

### Description of the Related Art

Three-dimensional (3D) television has been a technology trend in recent years that is targeted to bring viewers sensational viewing experience. Various technologies have been developed to enable 3D. Among them, the multi-view video is a key technology for 3DTV application among others. The traditional video is a two-dimensional (2D) medium that only provides viewers a single view of a scene from the perspective of the camera. However, the multi-view video is capable of offering arbitrary viewpoints of dynamic scenes and provides viewers the sensation of realism.

The multi-view video is typically created by capturing a scene using multiple cameras simultaneously, where the multiple cameras are properly located so that each camera captures the scene from one viewpoint. Accordingly, the multiple cameras will capture multiple video sequences. In order to provide more views, more cameras have been used to generate Multiview video with a large number of video sequences associated with the views. Accordingly, the multi-view video will require a large storage space to store and/or a high bandwidth to transmit. Therefore, multi-view video coding techniques have been developed in the field to reduce the required storage space of the transmission bandwidth. A straightforward approach may simply apply conventional video coding techniques to each single-view video sequence independently and disregard any correlation among different views. In order to improve multi-view video coding efficiency, typical multi-view video coding always exploits inter-view redundancy.

FIG. 1 illustrates an example of a prediction structure for 3D video coding. The vertical axis represents different views and the horizontal axis represents different time instances that the pictures are captured. In addition to a color image, a depth image is also captured at each view and each time instances. For example, for view V0, color images 110C, 111C, and 112C are captured corresponding to time instances T0, T1 and T2 respectively. Also, depth images 110D, 111D, and 112D are captured along with the color images corresponding to time instances T0, T1 and T2 respectively. Similarly, color images 120C, 121C, and 122C and associated depth images 120D, 121D, and 122D are captured corresponding to time instances T0, T1 and T2 respectively for view V1, and color images 130C, 131C, and 132C and associated depth images 130D, 131D, and 132D are captured corresponding to time instances T0, T1 and T2 respectively for view V2. Conventional video coding based on inter/intra-prediction can be applied to images in each video. For example, in view V1, images 120C and 122C are used for temporal prediction of image 121C. In addition, inter-view prediction serves as another dimension of prediction in addition to the temporal prediction. Accordingly, the term prediction dimension is used in this disclosure to refer to the prediction axis that video information along the axis is used for prediction. Therefore, the prediction dimension may refer to the inter-view prediction or the temporal prediction. For example, in time T1, image 111C from view V0 and image 131C from view V2 can be used to predict image 121C of view V1. Furthermore, the depth information associated with the scene is also included in the bit stream to provide support for interactive applications. The depth information can also be used for synthesizing virtual views from intermediate viewpoints.

In order to reduce the bit-rate for transmitting motion vectors (MVs) for coding the multi-view video, motion skip mode was disclosed to share the previously encoded motion information of adjacent views. As shown in FIG. 2, the motion skip mode includes two steps. In the first step, co-located block 212 of picture 222 in a neighboring view is identified for current block 210 of picture 220 in the current view. The co-located block 212 is identified by determining global disparity vector 230 between the current picture 220 in the current view and the co-located picture 222 in the neighboring view. In the second step, the motion information of the co-located block 212 in the co-located picture 222 is shared with the current block 210 in the current picture 220. For example, motion vectors 242 and 252 of the co-located block 212 can be shared by the current block 210. The motion vectors 240 and 250 for the current block 210 may be derived from motion vectors 242 and 252.

High Efficiency Video Coding (HEVC) is a new international video coding standard that is under development by the Joint Collaborative Team on Video Coding (JCT-VC). In the HEVC Working Draft Version 3.0 (WD-3.0) and the HEVC Test Model Version 3.0 (HM-3.0), a hybrid block-based motion-compensated DCT-like transform coding architecture, similar to previous coding standards such as MPEG-4 and AVC/H.264, is used. However, there are also new features and coding tools that are introduced. For example, the basic unit for compression, termed Coding Unit (CU), is a 2N×2N square block, and each CU can be recursively split into four smaller CUs until the predefined minimum size is reached. Each CU contains one or multiple prediction units (PUs), where the PU is used as the block unit for prediction process. The PU sizes can be 2N×2N, 2N×N, N×2N, and N×N.

In order to increase the coding efficiency of motion vector coding in HEVC, the motion vector competition (MVC) based scheme is applied to select one motion vector predictor (MVP) among a given MVP candidate set, which includes spatial and temporal MVPs. There are three inter-prediction modes, i.e., Inter, Skip, and Merge included in HM-3.0. The Inter mode performs motion-compensated predictions based on transmitted motion vectors (MVs), while the Skip and Merge modes utilize motion inference methods to determine the motion information from spatially neighboring blocks (spatial candidates) or a temporal block (temporal candidate) located in a co-located picture where the co-located picture is the first reference picture in list 0 or list 1 as indicated in the slice header.

When a PU is coded in either Skip or Merge mode, no motion information is transmitted except for the index of the selected candidate. For a Skip-mode PU, the residual signal is not transmitted either. For the Inter in HM-3.0, the advanced motion vector prediction (AMVP) scheme is used to select a motion vector predictor among an AMVP candidate set including two spatial MVPs and one temporal MVP. As for the Merge and Skip modes in HM-3.0, the Merge scheme is used to select a motion vector predictor among a Merge candidate set containing four spatial MVPs and one temporal MVP. Based on the rate-distortion optimization (RDO) decision, the encoder selects a final MVP from a given candidate set of MVPs for Inter, Skip, or Merge mode and transmits the index of the selected MVP to the decoder. The selected MVP may be linearly scaled according to temporal distances.

For the Inter mode, the reference picture index is explicitly transmitted to the decoder. The MVP is then selected among the candidate set for a given reference picture index. FIG. 3 illustrates the MVP candidate set for the Inter in HM-3.0, where two spatial MVPs and one temporal MVP are included:
1. Left predictor (the first available motion vector from A₀ or A₁)
2. Top predictor (the first available motion vector from B₀, B₁ or Bₙ₊₁)
3. Temporal predictor (the first available motion vector from T_{BR} or T_{CTR})

The temporal predictor is derived from a block (T_{BR} or T_{CTR}) located in a co-located picture where the co-located picture is the first reference picture in list 0 or list 1. The block where a temporal MVP is selected from may have two MVs: one from list 0 and the other from list 1. The temporal MVP is derived based on the MV from list 0 or list 1 according to the following rules:
1. The MV that crosses the current picture is chosen first.
2. If both MVs cross or both do not cross the current picture, the one with same reference list as the current list will be chosen.

A priority-based scheme is applied for deriving each spatial MVP. The spatial MVP can be derived from a different list and a different reference picture. The selection is based on a predefined order as follows:
1. The MV from the same reference list and the same reference picture;
2. The MV from the other reference list and the same reference picture;
3. The scaled MV from the same reference list and a different reference picture; and
4. The scaled MV from the other reference list and a different reference picture.

In HM-3.0, if a particular block is encoded as Merge or Skip modes, a MVP index is incorporated in the bitstream to indicate which MVP among the MVP candidate set is used for the block to be merged. To follow the essence of motion information sharing, each merged PU reuses the MV, prediction direction, and reference picture index of the selected candidate. The prediction direction refers to the temporal direction associated with reference picture, such as list 0 (L0)/list 1 (L1) or Bi-prediction. It is noted that if the selected MVP is a temporal MVP, the reference picture index is always set to the first reference picture. FIG. 4 illustrates the candidate set of MVPs for Merge and Skip modes in HM-3.0, where four spatial MVPs and one temporal MVP are included:
1. Left predictor (Aₘ)
2. Top predictor (Bₙ)
3. Temporal predictor (the first available motion vector from T_{BR} or T_{CTR})
4. Above right predictor (B₀)
5. Below left predictor (A₀)

As shown above, HEVC uses advanced MVP derivation to reduce the bitrate associated with motion vectors. It is desirable to extend the advanced MVP technique to 3D video coding to improve the coding efficiency.

### BRIEF SUMMARY OF THE INVENTION

A method and apparatus for deriving MV/MVP (motion vector or motion vector predictor) or DV/DVP (disparity vector or disparity vector predictor) associated Skip mode, Merge mode or Inter mode for a block of a current picture in three-dimensional video coding using spatial prediction, temporal prediction and inter-view prediction are disclosed. Embodiments according to the present invention select the MV/MVP or the DV/DVP from spatial candidates, temporal candidates and inter-view candidates. The spatial candidates are associated with neighboring blocks of the block in the current picture; the temporal candidates are associated with temporal co-located blocks of one or more temporal co-located pictures; and the inter-view candidates are associated with an inter-view co-located block associated with one or more inter-view co-located pictures corresponding to the block. The MVP or the DVP selected can be used as a candidate for the Inter mode in the three-dimensional video coding. The MV or the DV selected can be used as a candidate for the Merge or the Skip mode in the three-dimensional video coding.

One aspect of the present invention addresses derivation of the spatial candidates. The spatial candidates can be used to derive MV/MVP or DV/DVP. In this case, for a given prediction dimension and a target reference picture as indicated by a given reference picture index of a given reference list, the spatial candidate can be derived from the neighboring blocks associated with the target reference picture from the given reference list or other reference list. Alternatively, the spatial candidate can be derived from the neighboring blocks associated with other reference pictures from the given reference list or the other reference list.

Another aspect of the present invention addresses derivation of the temporal candidates. The temporal candidates can be used to derive MV/MVP or DV/DVP. In this case, for a given prediction dimension and a target reference picture as indicated by a given reference picture index of a given reference list, the temporal candidate can be derived from the temporal co-located blocks of temporal co-located pictures. The temporal co-located blocks are associated with the target reference picture in the given reference list or other reference list, or associated with other reference picture in the given reference list or the other reference list.

Yet another aspect of the present invention addresses derivation of the inter-view candidates. The inter-view candidates can be used to derive MV/MVP or DV/DVP. In this case, for a given prediction dimension and a target reference picture as indicated by a given reference picture index of a given reference list, the inter-view candidate can be derived from the inter-view co-located blocks of inter-view co-located pictures. The inter-view co-located blocks are associated with the target reference picture in the given reference list or other reference list, or associated with other reference picture in the given reference list or the other reference list.

In another embodiment of the present invention, a depth candidate is derived from the DV associated with a corresponding co-located block by warping the block of the current picture onto the picture based on depth information.

### BRIEF DESCRIPTION OF DRAWINGS

FIG. 1 illustrates an example of prediction structure for 3D video, where the prediction comprises temporal and inter-view predictions.

FIG. 2 illustrates an example of skip mode for 3D video, where the co-located block is determined using Global Disparity Vector (GDV).

FIG. 3 illustrates an example of Motion Vector Predictor (MVP) candidate set for Inter mode in HM-3.0.

FIG. 4 illustrates an example of Motion Vector Predictor (MVP) candidate set for Merge mode in HM-3.0.

FIG. 5 illustrates an example of Motion Vector (MV)/Disparity Vector (DV) candidate derivation for 3D video coding according to the present invention.

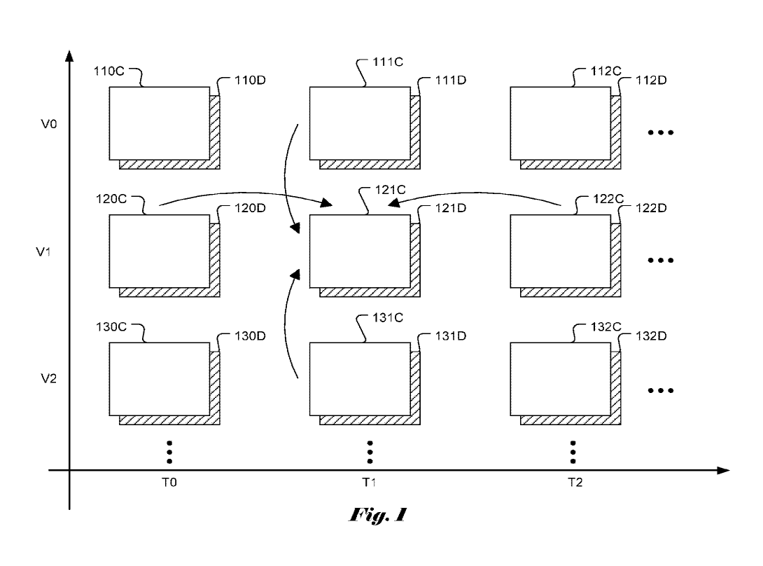

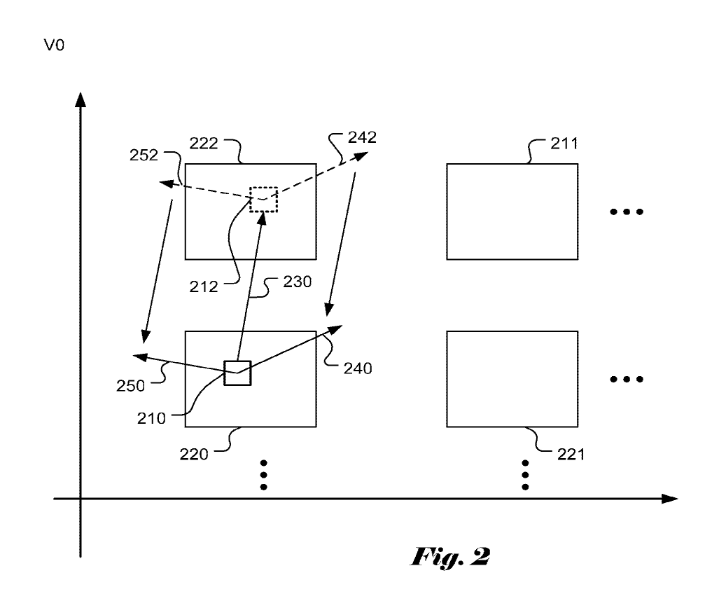

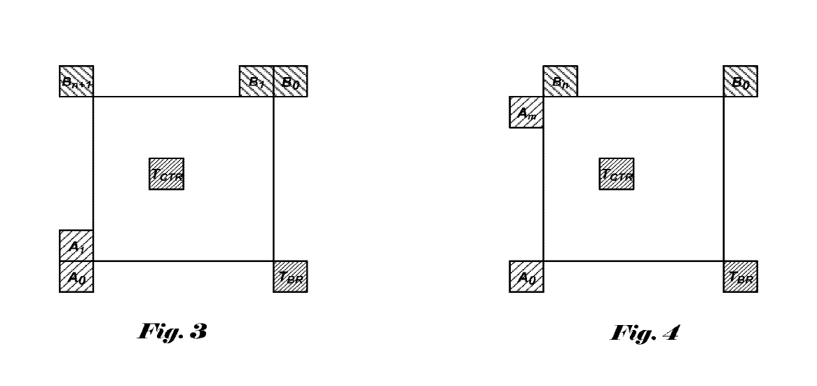

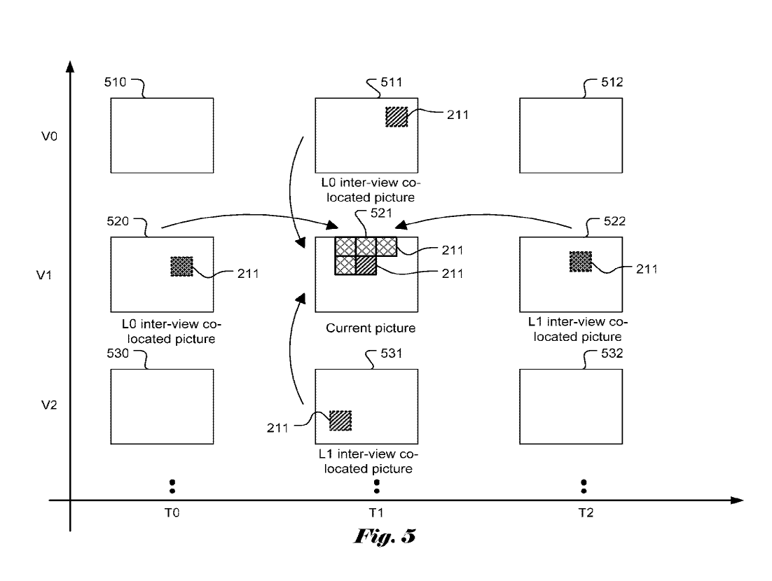

### DETAILED DESCRIPTION OF THE INVENTION

In the present invention, various prediction schemes are applied to derive Motion Vector (MV)/Disparity Vector (DV) and Motion Vector Predictor (MVP)/Disparity Vector Predictor (DVP) for Skip, Merge and Inter modes in 3D video coding.

FIG. 5 illustrates a scenario that the MV(P)/DV(P) candidates for a current block are derived from spatially neighboring blocks, temporally co-located blocks in the co-located pictures in list 0 (L0) or list 1 (L1), and inter-view co-located blocks in the inter-view co-located picture. Pictures 510, 511 and 512 correspond to pictures from view V0 at time instances T0, T1 and T2 respectively. Similarly, pictures 520, 521 and 522 correspond to pictures from view V1 at time instances T0, T1 and T2 respectively and pictures 530, 531 and 532 correspond to pictures from view V2 at time instances T0, T1 and T2 respectively. The pictures shown in FIG. 5 can be the color images or the depth images. The derived candidates are termed as spatial candidate (spatial MVP), temporal candidate (temporal MVP) and inter-view candidate (inter-view MVP). In particular, for temporal and inter-view candidate derivation, the information to indicate whether the co-located picture is in list 0 or list 1 can be implicitly derived or explicitly transmitted in different levels of syntax (e.g. sequence parameter set (SPS), picture parameter set (PPS), adaptive parameter set (APS), Slice header, CU level, largest CU level, leaf CU level, or PU level). The position of the inter-view co-located block can be determined by simply using the same position of the current block or using a Global Disparity Vector (GDV) or warping the current block onto the co-located picture according to the depth information.

The candidate can also be derived based on the vector corresponding to warping the current block onto the co-located picture according to the depth information. Accordingly, the candidate that is derived using the depth information is termed as depth candidate.

The motion vector competition (MVC) based scheme is then applied to select one Motion Vector Predictor (MVP)/Disparity Vector Predictor (DVP) among a candidate set of MVPs/DVPs which includes spatial, temporal, inter-view, and depth candidates. The index of the selected candidate is then transmitted to the decoder.

When a block is encoded as a Merge or Skip mode, the merge index is incorporated in the bitstream to indicate which MVP/DVP among the MVP/DVP candidate set is used for this block to be merged. The MVP/DVP candidate includes the spatial candidates (spatial MVPs/DVPs), temporal candidates (temporal MVPs/DVPs), inter-view candidates (inter-view MVPs/DVPs) and depth candidates. Bitrate associated with motion information is reduced by sharing the motion information with other coded blocks, where each merged PU reuses the MV/DV, prediction dimension, prediction direction, and reference picture index of the selected candidate. A merge index is transmitted to the decoder to indicate which candidate is selected for the Merge mode.

Various embodiments of the present invention to derive spatial candidate are disclosed herein. In one embodiment for spatial candidate derivation, the spatial candidate is derived from the MVs of the neighboring blocks if the spatial candidate is used to predict motion vectors. Similarly, the spatial candidate can also be derived from the DVs of the neighboring blocks if the spatial candidate is used to predict the disparity vector.

In another embodiment of the present invention for the spatial candidate derivation, the spatial candidate can be derived from the MVs and DVs of the neighboring blocks if the spatial candidate is used to predict motion vectors. Similarly, the spatial candidate can also be derived from the MVs and DVs of the neighboring blocks if the spatial candidate is used to predict the disparity vector.

In yet another embodiment of the present invention for the spatial candidate derivation, the spatial candidate derived based on MV or MV/DV of neighboring blocks according to the above embodiments can be further used to derive the spatial candidate. When the target reference picture is identified as indicated by the given reference picture index of the given reference list, the spatial candidates can be derived from an MV/DV pointing to the target reference picture either from the given reference list or the other reference list. For example, if all the neighboring blocks do not have the MV/DV pointing to the target reference in the given reference list, the candidate can be derived as the first available MV/DV pointing to the target reference picture in the other reference list from the neighboring blocks.

In an embodiment similar to the above embodiment, the spatial candidate derived based on MV or MV/DV of neighboring blocks according to the above embodiments can be further used to derive the spatial candidate. When the target reference picture is identified as indicated by the given reference picture index of the given reference list, the spatial candidates can be derived from an MV/DV pointing to the target reference picture or from an MV/DV pointing to the reference picture other than target reference picture in the same given reference list. For example, if all the neighboring blocks do not have the MV/DV pointing to the target reference picture, the candidate can be derived as the scaled MV/DV based on the first available MV pointing to the other reference pictures from the neighboring blocks.

In another embodiment similar to the above embodiment, the spatial candidate derived based on MV or MV/DV of neighboring blocks according to the above embodiments can be further used to derive spatial candidate. When the target reference picture is identified as indicated by the given reference picture index of the given reference list, the spatial candidates can be derived from the other reference list or other reference picture index based on the following order:
Search MV/DV pointing to the target reference picture within the given reference list;
Search MV/DV pointing to the target reference picture within the other reference list;
Search MV/DV pointing to the other reference pictures within the given reference list. The derived MV/DV is then scaled according to the temporal distance/inter-view distance; and
Search MV/DV pointing to the other reference pictures within the other reference list. The derived MV/DV is then scaled according to the temporal distance/inter-view distance.

For the spatial candidate derivation for Merge and Skip mode, the prediction information of the spatial candidate includes the prediction dimension (Temporal or Inter-View), prediction direction (L0/L1 or Bi-prediction), reference picture index and MVs/DVs. The information of the spatial candidate directly reuses the prediction information of the selected neighboring block used to derive the spatial candidate. The prediction information can be directly used by the current PU if that spatial candidate is selected.

Various embodiments of the present invention to derive temporal candidate are also disclosed herein. In one embodiment for temporal candidate derivation, the temporal candidate is derived from the MVs of the temporal co-located blocks if the temporal candidate is used to predict motion vectors. Similarly, the temporal candidate is derived from the DVs of the temporal co-located blocks if the temporal candidate is used to predict the disparity vector.

In another embodiment for temporal candidate derivation, the temporal candidate can be derived from the MVs and DVs of the temporal co-located blocks if the temporal candidate is used to predict motion vectors. Similarly, the temporal candidate can be derived from the MVs and DVs of the temporal co-located blocks if the temporal candidate is used to predict the disparity vector.

In yet another embodiment of the present invention for the temporal candidate derivation, the temporal candidate derived based on the MV or MV/DV of the temporal co-located blocks according to the above embodiments can be further used to derive the temporal candidate. For example, when the reference list and the co-located picture are provided, the MV/DV candidate can be derived by searching the MVs/DVs with the associated reference list same as the given reference list. The derived MV/DV is then scaled according to the temporal distance/inter-view distance. In another example, when the reference list and the co-located picture are provided, the MV/DV candidate can be derived by searching MV/DV crossing the current picture in the temporal/view dimension. The derived MV/DV is then scaled according to the temporal distance/inter-view distance. In yet another example, when the reference list and the co-located picture are provided, the MV/DV candidate can be derived according to the following order:
1. Search MV/DV crossing the current picture in the temporal/view dimension; and
2. If both MVs/DVs cross the current picture or both do not cross, the MV/DV with same reference list as the current list will be chosen.
The derived MV/DV is then scaled according to the temporal distance/inter-view distance.

In yet another embodiment of the present invention for the temporal candidate derivation, the temporal candidate derived based on MV or MV/DV of temporal co-located blocks according to the above embodiments can be further used to derive the temporal candidate. When the reference list is provided, the MV/DV candidate can be derived based on the MV/DV from list 0 or list 1 of the co-located block in the co-located picture in list 0 or list 1 according to a given priority order. The priority order is predefined, implicitly derived or explicitly transmitted to the decoder. The derived MV/DV is then scaled according to the temporal distance/inter-view distance. An example of the priority order is shown as follows, where the current list is assumed to be list 0:
1. Scaled MV/DV from list 0 of the co-located block of the co-located picture in list 1;
2. Scaled MV/DV from list 1 of the co-located block of the co-located picture in list 0;
3. Scaled MV/DV from list 0 of the co-located block of the co-located picture in list 0; and
4. Scaled MV/DV from list 1 of the co-located block of the co-located picture in list 1.

For the temporal candidate derivation for Merge and Skip mode, if the prediction dimension of the temporal co-located block is inter-view dimension, the prediction information, such as the prediction dimension (Temporal or Inter-view), prediction direction (L0/L1 or Bi-prediction), reference picture index and DVs of the temporal co-located block can be directly used by the current PU if the temporal candidate is selected.

For the temporal candidate derivation for Merge and Skip mode, if the prediction dimension of the temporal co-located block is temporal dimension, the reference picture index can be transmitted explicitly or derived implicitly. The prediction information, such as the prediction dimension, prediction direction (L0/L1 or Bi-prediction) and MVs of the temporal co-located block can be directly used by the current PU if the temporal candidate is selected. The derived MV is then scaled according to the temporal distance. For the derivation of the reference picture index, it can be implicitly derived based on the median/mean or the majority of the reference picture indices from the neighboring blocks.

Various embodiments of the present invention to derive inter-view candidates are also disclosed herein. In one embodiment for inter-view candidate derivation, the inter-view candidate is derived from MVs of the inter-view co-located blocks if the inter-view candidate is used to predict a motion vector. Similarly, the inter-view candidate is derived from DVs of the inter-view co-located blocks if the inter-view candidate is used to predict a disparity vector. The position of the co-located block in inter-view dimension can be determined by using the same position of the current block in the inter-view co-located picture, using a Global Disparity Vector (GDV), or warping the current block onto the inter-view co-located picture according to the depth information.

In another embodiment for inter-view candidate derivation, the inter-view candidate can be derived from MVs and DVs of the inter-view co-located blocks if the inter-view candidate is used to predict the motion vector. Similarly, the inter-view candidate can be derived from the MVs and DVs of the inter-view co-located blocks if the inter-view candidate is used to predict the disparity vector. The position of the co-located block in inter-view dimension can be determined by using the same position of the current block in the inter-view co-located picture, using a Global Disparity Vector (GDV), or warping the current block onto the inter-view co-located picture according to the depth information.

In yet another embodiment of the present invention for the inter-view candidate derivation, the inter-view candidate derived based on MV or MV/DV of the inter-view co-located blocks according to the above embodiments can be further used to derive the inter-view candidate. For example, when the reference list and the co-located picture are provided, the MV/DV candidate can be derived by searching the MVs/DVs with associated reference list same as the given reference list. The derived MV/DV is then scaled according to the temporal distance/inter-view distance. In another example, when the reference list and the co-located picture are provided, the MV/DV candidate can be derived by searching the MV/DV that crosses the current picture in the temporal/inter-view dimension. The derived MV/DV is then scaled according to the temporal distance/inter-view distance. In yet another example, when the reference list and the co-located picture are provided, the MV/DV candidate can be derived based on the following order:
1. Search the MV/DV that crosses the current picture in the temporal/inter-view dimension; and
2. If both MVs/DVs cross or both do not cross the current picture, the MV/DV with same reference list as the current list will be chosen.
The derived MV/DV is then scaled according to temporal distance/inter-view distance.

In yet another example, when the reference list is provided, the MV/DV candidate can be derived based on the MV/DV from list 0 or list 1 of the co-located block in the co-located picture in list 0 or list 1 according to a given priority order. The priority order can be pre-defined, implicitly derived, or explicitly transmitted to the decoder. The derived MV/DV is then scaled according to the temporal distance/inter-view distance. An example of the priority order is as follows, where the current list is assumed to be list 0:
1. Scaled MV/DV from list 0 of the co-located block of the co-located picture in list 1;
2. Scaled MV/DV from list 1 of the co-located block of the co-located picture in list 0;
3. Scaled MV/DV from list 0 of the co-located block of the co-located picture in list 0; and
4. Scaled MV/DV from list 1 of the co-located block of the co-located picture in list 1.

For the inter-view candidate derivation for Merge and Skip mode, if the prediction dimension of the inter-view co-located block is temporal dimension, the prediction information, such as prediction dimension, prediction direction (L0/L1 or Bi-prediction), reference picture index and MVs of the inter-view co-located block can be used directly by the current PU if the inter-view candidate is selected.

The position of the co-located block in inter-view dimension can be determined using the same position of the current block in the inter-view co-located picture, using a global disparity vector (GDV), or warping the current block onto the inter-view co-located picture according to the depth information.

For the inter-view candidate derivation for Merge and Skip mode, if the prediction dimension of the inter-view co-located block is inter-view dimension, the reference picture index could be transmitted explicitly or derived implicitly. The prediction information, such as prediction dimension, prediction direction (L0/L1 or Bi-prediction) and DVs of the inter-view co-located block can be used directly by the current PU if the inter-view candidate is selected. The derived DV is then scaled according to the inter-view distance. For the derivation of reference picture index, it can be implicitly derived based on the median/mean or the majority of the reference picture indices from the neighboring blocks.

The position of the co-located block in inter-view dimension can be determined using the same position of current block in the inter-view co-located picture or using a Global Disparity Vector (GDV) or warping the current block onto the inter-view co-located picture according to the depth information.

Embodiments of spatial candidate derivation, temporal candidate derivation or inter-view candidate derivation for 3D video coding according to the present invention as described above may be implemented in various hardware, software codes, or a combination of both. For example, an embodiment of the present invention can be a circuit integrated into a video compression chip or program codes integrated into video compression software to perform the processing described herein. An embodiment of the present invention may also be program codes to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware codes may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of deriving motion vector or motion vector predictor (MV/MVP) or disparity vector or disparity vector predictor (DV/DVP) associated Skip mode, Merge mode or Inter mode for a block of a current picture in three-dimensional video coding using prediction dimension consisting of temporal prediction and inter-view prediction, the method comprising:
determining one or more spatial candidates, one or more temporal candidates, or both said one or more spatial candidates and said one or more temporal candidates, wherein said one or more spatial candidates are associated with each of one or more neighboring blocks of the block; and wherein said one or more temporal candidates are associated with each of one or more temporal co-located blocks of one or more temporal co-located pictures of the block;
using depth information corresponding to the block to determine one or more inter-view candidates associated with the inter-view co-located block associated with said one or more inter-view co-located pictures corresponding to the block;
selecting the MV/MVP or DV/DVP from said one or more spatial candidates, said one or more temporal candidates and said one or more inter-view candidates; and
providing the selected MV/MVP or DV/DVP to the block coded as the Skip mode, the Merge mode or the Inter mode.

2. The method of claim 1, wherein said one or more inter-view candidates is determined based on a vector derived according to the depth information.

3. The method of claim 2, wherein the vector is derived from the position of the inter-view co-located block.

4. The method of claim 1, wherein a position of the inter-view co-located block is determined according to the depth information corresponding to the block.

5. The method of claim 4, wherein a vector is derived according to the depth information corresponding to the block and the position of the inter-view co-located block is located using the vector.

6. The method of claim 1, wherein the current block is warped onto the co-located picture according to the depth information to determine the position of the inter-view co-located block.

7. The method of claim 1, wherein the MV or the DV selected is scaled according to an inter-view distance.

8. An apparatus for deriving motion vector or motion vector predictor (MV/MVP) or disparity vector or disparity vector predictor (DV/DVP) associated Skip mode, Merge mode or Inter mode for a block of a current picture in three-dimensional video coding using prediction dimension consisting of temporal prediction and inter-view prediction, the apparatus comprising at least one circuit configured for:
determining one or more spatial candidates, one or more temporal candidates, or both said one or more spatial candidates and said one or more temporal candidates, wherein said one or more spatial candidates are associated with each of one or more neighboring blocks of the block; and wherein said one or more temporal candidates are associated with each of one or more temporal co-located blocks of one or more temporal co-located pictures of the block;
using depth information corresponding to the block to determine one or more inter-view candidates associated with the inter-view co-located block associated with said one or more inter-view co-located pictures corresponding to the block;
selecting the MV/MVP or DV/DVP from said one or more spatial candidates, said one or more temporal candidates and said one or more inter-view candidates; and
providing the selected MV/MVP or DV/DVP to the block coded as the Skip mode, the Merge mode or the Inter mode.
